(19) United States
(12) Patent Application Publication
(10) Pub. No.: US 2011/0232020 A1
(43) Pub. Date: Sep. 29, 2011

(54) MEDICAL IMPLEMENT CLEANING DEVICE WITH FRICTION-BASED FITTING AND ENERGY DIRECTORS

(75) Inventors: Bobby E. Rogers, San Diego, CA (US); Paul DiPerna, San Diego, CA (US)

(73) Assignee: Ivera Medical Corporation, San Diego, CA (US)

(21) Appl. No.: 13/072,653

(22) Filed: Mar. 25, 2011

Related U.S. Application Data
(60) Provisional application No. 61/318,249, filed on Mar. 26, 2010.

(51) Int. Cl. B08B 7/00

(52) U.S. Cl. 15/246

(57) ABSTRACT

A cleaning device for a medical implement is disclosed. The cleaning device includes a cap having an opening to an inner cavity, the opening being adapted to receive a site of the medical implement. The cleaning device further includes a cleaning material that contains a cleaning agent prior to receipt of the site of the medical implement, i.e. the cleaning material is pre-loaded with the cleaning agent. The cleaning material is at least partially secured in the inner cavity and adapted to swab and clean the site with the cleaning agent. The cap further includes a friction-forming member for creating a friction-based fitting of the cap onto the site of the medical implement.

### CROSS REFERENCE TO RELATED APPLICATIONS

This application claims the benefit of priority under 35 U.S.C. §119 to U.S. Provisional Patent Application Ser. No. 61/318,249, filed on Mar. 26, 2010, entitled, “Medical Implement Cleaning Device With Friction-Based Fitting And Energy”, which is incorporated by reference, herein, in its entirety.

### BACKGROUND

The present invention relates to cleaning devices, and more particularly to a universal connector cap that cleanses a connector of pathogens or other harmful materials or contaminants and employs friction-based fitting to a connector site or other medical implement.

In the medical field there is often a need to connect tubing to a variety of devices to help with the administration of fluids to a patient. To allow tubing and components from different manufacturers of a variety of devices to connect with one another, a standard connector type was developed. The connector type generally consists of a male connector (or “port,” which is used interchangeably herein) being inserted into a female connector whereby friction would keep them together, as shown in FIG. 1A. The taper of the male connector on the left is adapted to closely match the taper of the female connector on the right to create a friction or compression type connection that is fluid tight. For infusion or aspiration of fluids to or from an intravenous or arterial access line or device, i.e. including, without limitation, a catheter, IV set, extension set stopcock, syringe, valve, etc., this type of connector is known as a Luer. The dimensions of Luer connectors can be found in ISO Standards 594-1 and 594-2.

Luers were later improved with threading mechanisms to allow and assist the two connectors to screw together, whereby friction was again the holding force. This threading was merely an enhancement to enable a user to more easily drive the male and female connectors together. If a female port remains open when not connected, there is an increased risk of infections, leakage of fluid and other problems resulting from having open access to the patient. To eliminate this “open” problem, a rubber port can be used for the female connector that can keep the female port closed until used for injections, as shown in FIG. 1B. The rubber port was typically pierced with a needle, or could be removed to connect the female connector with other tubing.

The female connector was further improved with one of several other features, such as a split septum, biased septum, displaceable piston etc. that can be displaced from a closed position by the male connector when it needed to be out of the way, but which can spring back to the closed position as required. This device was highly desirable because it eliminated the dangerous needle and its closure was automatic. This device is commonly called a needleless adapter, or a Luer Activated Valve (LAV). For instance, the luer tapered male port on standard syringes can open a fluid path without a needle, through or around the displaced feature on the female side when the two were pressed or screwed together. After the injection of fluids, the syringe was unscrewed/removed. Upon removal, the needle-free feature (whether a biased plug/piston, split septum or other displaceable construct) is, without user interaction, automatically biased back into its normally closed position.

This improvement simplified the administration of fluids by removing needles and reducing open port risks but still necessitated the use of a disinfecting wipe prior to insertion since the outside features would still remain exposed to touch and air contamination.

Without a male feature, the friction that holds the cap to the valve is virtually nonexistent. A minor shaking or unscrewing action will dislodge the cap from the female side. Nearly all currently marketed threaded devices use a “screw” molding process to create the threads, similar to that used with a bolt. Without the addition of another piece, this method of manufacturing does not lead itself to development of a means of retaining a cap in place when the luer tapers are removed. In addition, using a traditional thread configuration is challenging because, despite the existence of the ISO standards, a large variation in thread designs on the female Luers still exists. This variation makes it extremely difficult to design a common solution. Use of the traditional “screw” molding process will likely not solve the problem.

There is a need for a means of preventing the cap from inadvertently being removed without the increased cost and user dissatisfaction of additional parts.

### SUMMARY

This document presents a cleaning device for a medical implement. The cleaning device includes a cap having an opening to an inner cavity, the opening being adapted to receive a site of the medical implement. The cleaning device further includes a compressible cleaning material that contains a cleaning agent prior to receipt of the site of the medical implement, i.e. the cleaning material is pre-loaded with the cleaning agent. The compressible cleaning material is at least partially secured in the inner cavity and adapted to swab and clean the site with the cleaning agent.

The cap further includes a friction-forming member for creating a friction-based fitting of the cap onto the site of the medical implement. Alternatively, the cap further includes a member, preferably protruding from threading at the opening of the inner cavity, that, once the cap is fitted onto the site of the medical implement, inhibits easy removal of the cap until a force exerted on the cap exceeds a certain threshold of force. The cap further includes one or more energy directors on which a threaded ring is mated to a receptacle in the cap. The cap can be filled with a cleaning material and cleaning solution, such as a foam pad with an antibacterial or antimicrobial solution. Alternatively, the cap can be filled with a gel, foam or wax that includes an antibacterial or antimicrobial component.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIGS. 1A-1C illustrate a threaded ring for a cap of a cleaning device.

FIGS. 2A-2D shows various views of a cap of a cleaning device.

FIG. 3 is a perspective view of a cleaning device formed of a cap connected with an inner threaded ring.

FIG. 4 is a cross sectional view of the cleaning device shown in FIG. 4.

Like reference symbols in the various drawings indicate like elements.

### DETAILED DESCRIPTION

An improved cleaning device acts as a combination cap and disinfecting swab, whereby it is screwed or is otherwise fitted onto a closed female side of a Luer activated valves (i.e. LAV). The cleaning device contains features to disinfect or sterilize the external surface of the closed female port, and further protects the surface from further contamination as long as it remains fitted on to the female port. The cleaning device typically does not include the male feature, the tapered cone, since its objective is to wipe the outer surface of the LAV, not to open the valve. LAVs are typically made of very rigid plastics such as polycarbonate or acrylic. The female connection of the LAV has threads and a root diameter.

A cleaning device in the form of a cap to clean the female connection of an LAV is provided, as exemplified in U.S. patent application Ser. No. 11/705,805, filed Feb. 12, 2007, the contents of which are incorporated by reference herein for all purposes. The cleaning device for a medical implement includes a cap having an opening to an inner cavity. An inner surface of the opening includes one or more threads adapted to receive a site of the medical implement. The cleaning device further includes a cleaning material formed of a compressible material that is at least partially secured in the inner cavity. The cleaning material contains a cleaning agent that effectively eliminates pathogens and other harmful materials from the site by twisting and fitting the cap onto the site, particularly if the cap is fitted onto the site for a period of time.

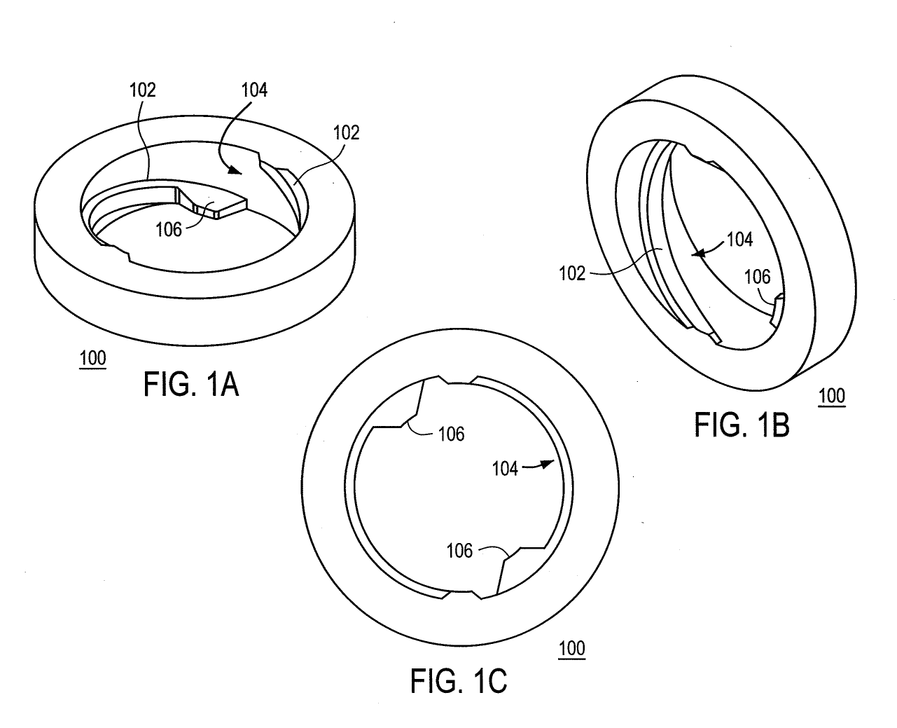

The one or more threads of the cleaning device can be provided by a threaded ring adapted to be fixedly positioned at the inner surface of the opening of the cap. FIGS. 1A-1C show various views of a threaded ring 100 for a cleaning device. One or more threads 102 encircle a portion of an inner surface 104 of the threaded ring 100, preferably two threads 102 extending about one-quarter to one-half circumference around the inner surface 104. A tab 106 extends as a further protrusion from each thread 102 and toward a center of the threaded ring 100, preferably at the lower terminus of each thread 102 (i.e. toward an opening of a cap in which the threaded ring 100 is placed, or at a leading side toward an LAV). Each tab 106 can be made thinner than the rest of the thread 102, to allow flexure or bending.

In preferred exemplary implementations, the threaded ring 100 can be formed by plastic injection molding. The threads 102 are formed such that the threaded ring 100 does not need to be unwound during molding or fabrication. The tabs 106 of each thread 102 engage with the outer threading of a valve or port, and any gap provided thereby allows for compatibility with many sized valves or ports, as well as allows limited evaporation or venting of cleaning solution (such as isopropyl alcohol) that might be inside the cap.

The threaded ring 100 is placed or otherwise connected to a cap (not shown) at the outer portion of an opening to the cap. The tabs 106 create friction on one or both outer sides of the female connection of the Luer, thereby preventing the cap from unscrewing from the female connection of the Luer. In some implementations, the threads 102 of the cap correspond to an ISO Luer Standard thread. Each tab 106 presses against the root diameter of the female luer and presses on the sides of the thread feature of the female connection, thereby creating friction. The threading and one or more protrusions cooperate to create a compression fit and to prevent the cap from accidentally coming off the site onto which it is fitted.

The threads 102 of the cap, and/or the tabs 106, i.e. protrusions of added material, can be made of a softer, more compressible material than the cap or the female connector, such as another type of plastic or a rubber, etc. These features pressing on the female side work in several ways. The tabs 106 can press against the more rigid female luer LAV root or body or threads to create friction. The tabs 106 can also displace plastic to create a single use scenario, where the part pressing on the thread of the LAV pushes against the outside of the thread or on the sides of the thread. The material of the tabs 106 can further deflect more in one direction than another, for example, to make placing a cap on a medical implement simple, and taking off the cap more difficult.

Additionally the cap can be configured for being pressed on instead of, or in addition to, being screwed on, with the tabs 106 from the inner surface 104 or threads 102 of the cap to press against the threads or roots of the female connection of the LAV, similar in function to a star retaining washer. A threaded ring 100 of a cap could have other features that create resistance against the LAV when the cap is pulled off. The tabs 106 as protruding “flaps” can be bendable to allow the cap to be forced over the female threads. Once past the threads or a section of threads, the “flaps” would naturally return to their unbent state to prevent the inadvertent removal of the cap. To remove, it may be necessary to unscrew the cap where the tabs 106 find the LAV thread track, or the user could just pull off the cap upon exceeding a certain threshold force to overcome the resistance provided by the tabs 106 and/or the threads of the cap.

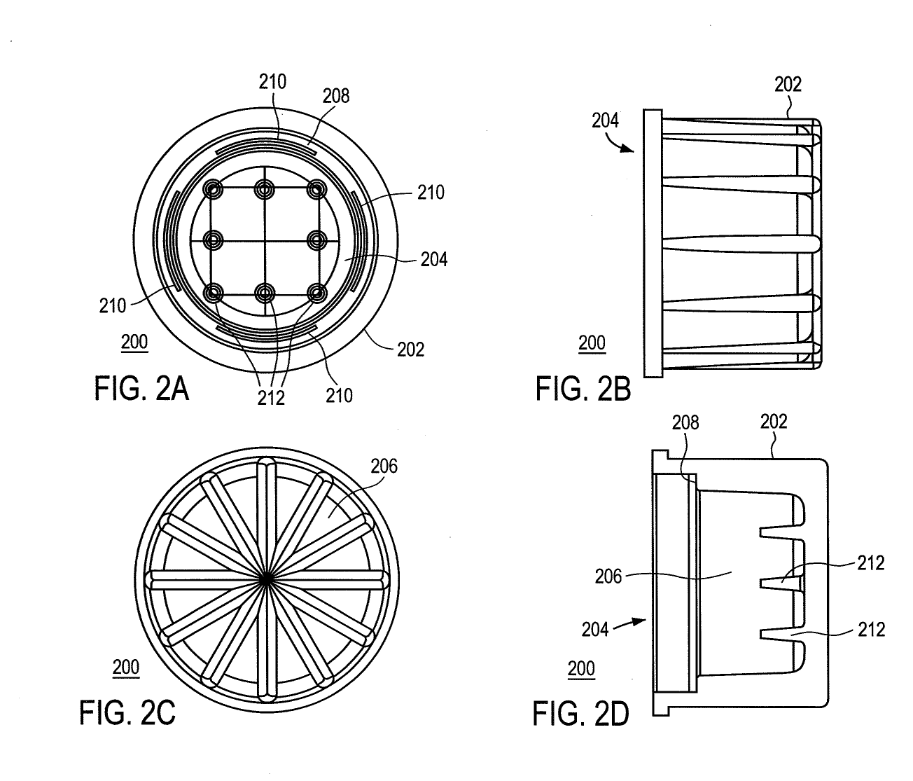

FIGS. 2A-D show various views of a cap portion 200 of a cleaning device. The cap portion 200 includes a cap 202 with an opening 204 to an interior cavity 206. The opening 204 is preferably slightly wider in diameter than the rest of the interior cavity 206 to form a receptacle 208 or inner ridge for the threaded ring 100, to be able to receive and connect with a threaded ring 100 as described above. The receptacle 208 includes a number of energy directors 210 in the form of bumps or protrusions that enable welding or bonding of the threaded ring 100 into the receptacle 208. The energy directors 210 also stabilize the threaded ring 100 for proper alignment and mounting, and can resist against turning the threaded ring 100 relative to the cap 202 when the cleaning device is screwed on or otherwise applied to a port or valve.

The top interior wall of the cap 202 may have one or more protrusions 212 extending up from the interior wall toward the opening 204 of the cap 202. The protrusions 212 can be used to grab a cleaning material such as foam, cotton, or other porous material, or provide stability to a thixotropic cleaning solution as an alternative. In some implementations, the protrusions 212 can be formed of a flexible material to contact and scrub the forward face of a valve or port, including, for example, the septum of a valve.

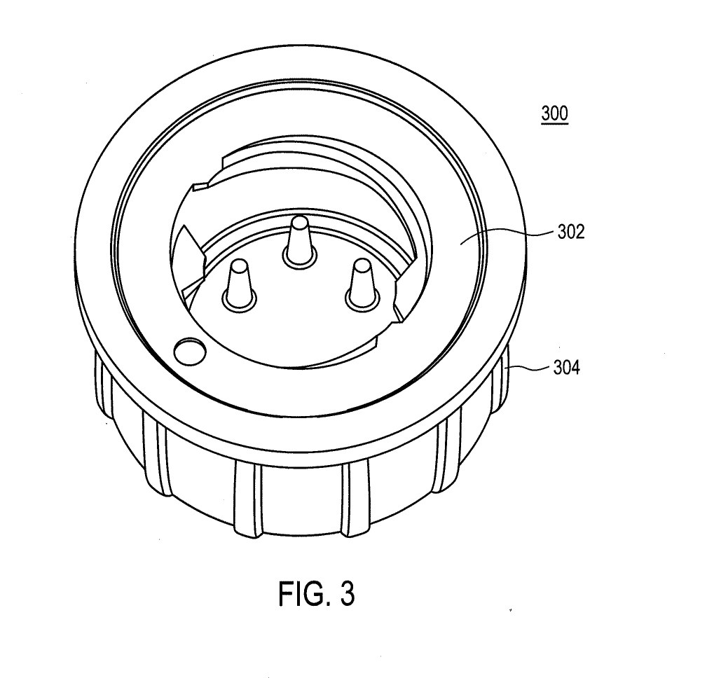

FIG. 3 is a top perspective view of a cleaning cap 300 with a threaded ring 302 attached to a cap 304 at an opening of the cap 304 to an inner cavity. The threaded ring is attached at a receptacle or outer channel formed at the opening of the cap 304. The threaded ring 302 may be attached to fit entirely within the receptacle, such that no gaps or apertures are left between the outside of the threaded ring 302 and the inside surface of the opening to the inner cavity of the cap 304. Alternatively, the threaded ring 302 may allow a slight gap or even a defined hole, aperture or vent at the interface with the cap's 304 inside surface, to allow aspiration or evaporation of any cleaning solution being held in the inner cavity of the cap 304. In one implementation, evaporation rates of the cleaning solution can be controlled by providing a specific-sized hole, aperture or vent, such that a time-related volume of evaporation can be determined to occur.

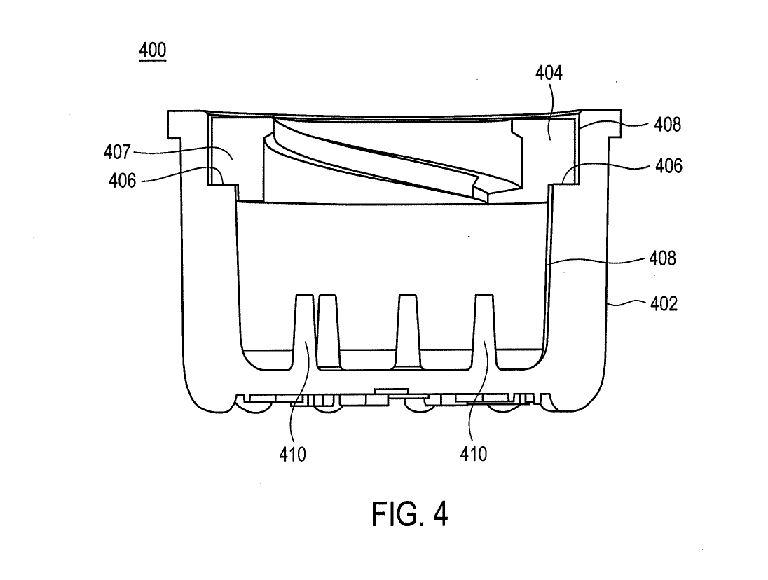

FIG. 4 is a cross-sectional view of a medical implement cleaning device 400 having a cap 402 with a threaded ring 404 mated thereon within a receptacle 406 of the inner surface 408 at the opening of the cap 402. An upper-facing surface of the receptacle 406 can include one or more energy directors 407. The energy directors 407 can be melted down as the threaded ring 404 is ultrasonically welded into place in the receptacle 406, for example. In some implementations, the threaded ring 404 can be formed with coincident holes or channels for receiving and connecting with the energy directors 407. Further welding or bonding of the threaded ring can occur as the energy directors 407 are melted down, either by thermal bonding or ultrasonic welding.

The interior wall of the cap 402 distal or opposite the opening may have one or more protrusions 410 extending up from the interior wall toward the opening of the cap 402. The protrusions 410 are sized and positioned to grab a cleaning material such as foam, cotton, or other porous material, or alternatively, provide stability to a thixotropic cleaning solution, or both. In some implementations, the protrusions 410 can be formed of a flexible material to contact and scrub the forward face of a valve or port, including, for example, the septum of a valve. In exemplary implementations, the cap 402 includes two to sixty or more protrusions 410, and preferably between six and twelve protrusions 410.

The inner cavity of the cap 402 can include a cleaning material laden with a cleaning solution. In some implementations, the cleaning material is a foam material, and the cleaning solution is a liquid that saturates the foam material. Suitable cleaning solutions include isopropyl alcohol, ethyl alcohol, CHG, choloroxylenol (PCMX), providone iodine, etc. The cleaning solution can also include emollients or other components.

In other implementations, the cleaning material and cleaning solution can be formed of a thixotropic substance such as a gel or foam, or of a fluid with high viscosity. The thixotropic substance can include a base viscous substance impregnated with a cleaning solution in a manner to maintain at least a certain degree of viscosity. The thixotropic substance can at least partially fill the interior cavity of the cap, and flow around the valve or port to cover a desired surface area when the cap is placed on the valve or port.

The opening of the cap 402 can be closed with a removable foil or lid. Alternatively, the cap 402 can be adhered to a tape or strip of material, such as in a linear or two-dimensional array or arrangement of a number of caps 402.

Although a few embodiments have been described in detail above, other modifications are possible. For example, the cap can include friction-forming members in which the threading has a gauge that increases inwardly from the opening toward an inside roof of the cap. Other embodiments may be within the scope of the following claims.

1. A cleaning device for a medical implement, the cleaning device comprising:
a cap having an outer surface including a plurality of vertical ridges on the outer surface, and having an opening to a single inner cavity, the opening being adapted to receive a site of the medical implement, the cap further including threading around a periphery of the single inner cavity, the threading including a friction-forming member for creating a friction-based fitting of the cap onto the site of the medical implement; and
a cleaning material provided in the single inner cavity prior to receipt of the site of the medical implement, the cleaning material containing a cleaning agent, the cleaning material adapted to clean the site with the cleaning agent upon receipt of the site of the medical implement into the single inner cavity.

2. The cleaning device in accordance with claim 1, wherein the cleaning material is a thixotropic fluid.

3. The cleaning device in accordance with claim 1, wherein the friction forming member is a tab extending out from a thread on an inside surface of a threaded ring that is attached to the periphery of an opening of the single inner cavity, the threaded ring forming the threading.

4. The cleaning device in accordance with claim 1, wherein the friction-forming member includes the threading having a gauge that increases inwardly from the opening toward an inside roof of the cap.

5. The cleaning device in accordance with claim 1, wherein the friction forming member includes a decreasing diameter of the threading inwardly from the opening toward an inside roof of the cap.

6. The cleaning device in accordance with claim 1, wherein the opening of the cap is oval-shaped.

7. The cleaning device in accordance with claim 1, further comprising one or more protrusions extending up from a top inner surface of the cap toward the opening to the single inner cavity.

8. A cleaning device for a medical implement, the cleaning device comprising:
a cap having an opening to an inner cavity, the opening being sized to receive a site of the medical implement;
one or more threads extending from an inner surface of the cap near the opening toward a center of the opening, the one or more threads extending at least partially around the opening; and
a flexible tab extending out from at least one of the one or more threads toward the center of the opening of the cap.

9. The cleaning device in accordance with claim 8, further comprising a ring connected to the cap to define the opening, the ring providing the one or more threads and the flexible tab.

10. The cleaning device in accordance with claim 8, wherein each of the one or more threads includes a flexible tab.

11. The cleaning device in accordance with claim 8, wherein the cap further includes an outer surface having a plurality of vertical ridges on the outer surface.

12. The cleaning device in accordance with claim 8, further comprising a cleaning material provided in the single inner cavity prior to receipt of the site of the medical implement, the cleaning material containing a cleaning agent, the cleaning material adapted to clean the site with the cleaning agent upon receipt of the site of the medical implement into the single inner cavity.

13. The cleaning device in accordance with claim 8, further comprising one or more protrusions extending toward the opening from an inner surface of the inner cavity opposite the opening.

14. The cleaning device in accordance with claim 8, further comprising a removable lid that covers the opening prior to receipt of the site of the medical implement.

15. A cleaning device for a medical implement, the cleaning device comprising:
a cap having an opening to an inner cavity, the opening being sized to receive a site of the medical implement;
one or more threads extending from an inner surface of the cap near the opening toward a center of the opening, the one or more threads extending at least partially around the opening, each of the one or more threads further including a flexible tab extending out from each of the one or more threads toward the center of the opening of the cap; and
one or more protrusions extending toward the opening from an inner surface of the inner cavity opposite the opening.

16. The cleaning device in accordance with claim 15, further comprising a removable cover that closes the opening.

17. The cleaning device in accordance with claim 16, further comprising a cleaning material provided in the single inner cavity prior to receipt of the site of the medical implement, the cleaning material containing a cleaning agent, the cleaning material adapted to clean the site with the cleaning agent upon receipt of the site of the medical implement into the single inner cavity.

18. The cleaning device in accordance with claim 16, wherein the removable cover includes a foil.

19. The cleaning device in accordance with claim 16, wherein the removable cover includes a strip of material to which one or more caps are removably attached at their respective openings.

20. The cleaning device in accordance with claim 15, further comprising at least one vent to vent the inner cavity.
